(19) United States
(12) Patent Application Publication
(10) Pub. No.: US 2022/0398643 A1
(43) Pub. Date: Dec. 15, 2022

(54) METHODS AND APPARATUS FOR AUTOMATICALLY RANKING ITEMS BASED ON MACHINE LEARNING PROCESSES

(71) Applicant: Walmart Apollo, LLC, Bentonville, AR (US)

(72) Inventors: Vidyashankar Sivakumar, San Jose, CA (US); Robert Wayne Macy, III, Davis, CA (US); Nikita Maple Sudan, Sunnyvale, CA (US); Rajyashree Mukherjee, San Carlos, CA (US)

(21) Appl. No.: 17/343,440

(22) Filed: Jun. 9, 2021

(51) Int. Cl. G06Q 30/06; G06F 16/957; G06Q 30/02; G06N 20/00; G06K 9/62

(52) U.S. Cl. CPC G06Q 30/0631; G06F 16/9574; G06Q 30/0201; G06N 20/00; G06K 9/6262

(57) ABSTRACT

This application relates to apparatus and methods for training machine learning models, and applying the trained models to determine an item's relevance to a search query. In some examples, features are generated based on item engagement data associated with a search query. First values are generated for each of a plurality of items based on the search query, a first attribute of each of the items, and the item engagement data. Second values are generated for the items based on the search query, the first attributes, a second attribute of each item, and the item engagement data. Third values are generated for the items based on the search query, the first attributes, a third attribute of each item, and the item engagement data. Features are generated based on the first, second, and third values, and a machine learning model is applied to the features to rank items.

### TECHNICAL FIELD

The disclosure relates generally to machine learning processes and, more specifically, to training machine learning processes, and applying the trained machine learning processes to automatically determine an item's relevance to a search query.

### BACKGROUND

At least some websites, such as retailer websites, allow a visitor to search for items. For example, the website may include a search bar that allows the visitor to enter search terms, such as one or more words, that the website uses to search for items. In response to the search terms, the website may display search results determined by a search algorithm, such as a machine learning model, implemented by the website. The search results may identify items that are offered for purchase by the retailer. These search results, however, can have drawbacks. For example, the search results may include items that are irrelevant to the person conducting the search query. In some cases, the search results may include items that do not correspond to the intent of the person conducting the search. In other examples, items that a person would be interested in may appear lower in the search results. As a result, the person conducting the search may need to spend time ignoring irrelevant search results before viewing relevant search results. As a result, a website visitor conducting a search may need to peruse through many search result items before potentially locating an item they are interested in. In addition, the website visitor may decide to visit a different website to purchase items, thereby potentially losing a sale on the original website. As such, there are opportunities to address the determination of search results to a search query to website visitors.

### SUMMARY

The embodiments described herein are directed to training machine learning models, and applying the trained machine learning models to generated features to determine an item's relevance to a search query. Search results to the search query may be determined based on the each item's determined relevancy. For example, a search request may be entered in a search bar of a website. In response, features may be generated based on one or more items and the search query, and the trained machine learning models may be applied to the generated features to determine search results. The website may, for example, display the determined search results. In some examples, more relevant items are displayed before less relevant items. For example, the search results may include a ranking of items, where more relevant items are ranked ahead of less relevant items. The items may then be displayed in ranked order.

The machine learning models may include, for example, decision tree models, random forest models, gradient boosting models, support-vector machine (SVM) models, neural networks, or any other suitable models. The models may be trained based on features generated from user session data, item catalog data, and search queries. For example, the models may be trained with features characterizing a query-item relevance. The query-item relevance may be based on a search query's determined explicit intent (e.g., a value based on a word or phrase appearing in the search query), and on the search query's determined implicit intent. Once trained, the machine learning model may be applied to features generated from a received search query and item catalog data to generate a query-item relevance score for each of a plurality of items. In some examples, the plurality of items may be ranked according to the generated query-item relevance score. Item advertisements, such as digital advertisements, may be provided for one or more of the ranked items. In some examples, digital advertisements for one or more of the plurality of items are displayed on a website in ranked order.

In some embodiments, a first value for each of a plurality of items is determined based on a first attribute of the plurality of items and search result engagements of each of the plurality of items for a search query. In addition, a second value for each of the plurality of items is determined based on a second attribute of the plurality of items and the search result engagements of each of the plurality of items for the search query. A third value for each of the plurality of items is also determined based on a third item attribute of the plurality of items and the search result engagements of each of the plurality of items for the search query. The first value may represent a value based on product type, for example. The second value may represent an explicit intent the search query (e.g., a brand specified in the search query) of, and the third value may represent an implicit intent of the search query (e.g., a type of material not specified in the search query).

A query-item value may then be determined for each of the plurality of items based on their corresponding first value, second value, and third value. For example, a model (e.g., algorithm) may be applied to the first value, second value, and third value of each item to generate the query-item value. The query-item values for each search query-item pair may be stored in a database.

In some examples, features are generated based on the final values for the plurality of items. For example, the final values may be stored within a feature vector as expected during training by a machine learning model. The machine learning model may be trained with the generated features.

In some embodiments, a search query is received from, for example, a web server. Based on the search query, features based on final values for one or more items are obtained from a database. For example, final values for items engaged in response to the search query are obtained from the database. Features may then be generated for each of the one or more items based on their corresponding final values. A trained machine learning model may be applied to the search query and the features to generate a ranking of the one or more items. Item advertisements for the one or more items may be displayed, such as on a website, based on the ranking.

Thus, the embodiments may allow a customer to be presented with search results that are more relevant to a customer conducting the search. For example, the embodiments may allow a retailer to present more relevant search results to customers. The embodiments may also allow a retailer to present items the customer may be interested in earlier in a search result listing. As a result, customer experience with a website may be improved. For example, the customer may more quickly locate an item of interest, which may save the customer time as well as encourage the customer to purchase the item. In addition, because a customer may now spend less time searching for an item, the customer may have additional time to consider additional items for purchase. In addition to or instead of these example advantages, persons of ordinary skill in the art would recognize and appreciate other advantages as well.

In accordance with various embodiments, exemplary systems may be implemented in any suitable hardware or hardware and software, such as in any suitable computing device. For example, in some embodiments, a computing device is configured to determine a first value for each of a plurality of items based on a first attribute of the plurality of items and engagements of each of the plurality of items corresponding to a search query. The computing device is also configured to determine a second value for each of the plurality of items is determined based on a second attribute of the plurality of items and the engagements of each of the plurality of items corresponding to the search query. Further, the computing device is configured to determine a third value for each of the plurality of items based on a third item attribute of the plurality of items and the engagements of each of the plurality of items corresponding to the search query. The computing device may also be configured to determine a query-item value each of the plurality of items based on their corresponding first value, second value, and third value. The computing device may further be configured to store the query-item values for each of the plurality of items in a database. In some examples, the computing device is configured to generate features based on the query-item values, and train a machine learning model with the generated features.

In some embodiments, a computing device is configured to receive a search query. The computing device is also configured to obtain, for each of a plurality of items, a query-item value from a database based on the search query. Moreover, the computing device is configured to generate features based on the obtained values, and apply a trained machine learning model to the generated features and the search query to determine a ranking of the plurality of items.

In some embodiments, a method is provided that includes determining a first value for each of a plurality of items based on a first attribute of the plurality of items and engagements of each of the plurality of items corresponding to a search query. The method also includes determining a second value for each of the plurality of items is determined based on a second attribute of the plurality of items and the engagements of each of the plurality of items corresponding to the search query. Further, the method includes determining a third value for each of the plurality of items based on a third item attribute of the plurality of items and the engagements of each of the plurality of items corresponding to the search query. The method also includes determining a query-item value each of the plurality of items based on their corresponding first value, second value, and third value. The method further includes storing the query-item values for each of the plurality of items in a database. In some examples, the method includes generating features based on the query-item values, and training a machine learning model with the generated features.

In some embodiments, a method is provided that includes receiving a search query. The method also includes obtaining, for each of a plurality of items, a query-item value from a database based on the search query. Moreover, the method includes generating features based on the obtained values, and applying a trained machine learning model to the generated features and the search query to determine a ranking of the plurality of items.

In yet other embodiments, a non-transitory computer readable medium has instructions stored thereon, where the instructions, when executed by at least one processor, cause a computing device to perform operations that include includes determining a first value for each of a plurality of items based on a first attribute of the plurality of items and engagements of each of the plurality of items corresponding to a search query. The operations also include determining a second value for each of the plurality of items is determined based on a second attribute of the plurality of items and the engagements of each of the plurality of items corresponding to the search query. Further, the operations include determining a third value for each of the plurality of items based on a third item attribute of the plurality of items and the engagements of each of the plurality of items corresponding to the search query. The operations also include determining a query-item value each of the plurality of items based on their corresponding first value, second value, and third value. The operations further include storing the query-item values for each of the plurality of items in a database. In some examples, the operations include generating features based on the query-item values, and training a machine learning model with the generated features

In yet other embodiments, a non-transitory computer readable medium has instructions stored thereon, where the instructions, when executed by at least one processor, cause a computing device to perform operations that include includes receiving a search query. The operations also include obtaining, for each of a plurality of items, a query-item value from a database based on the search query. Moreover, the operations include generating features based on the obtained values, and applying a trained machine learning model to the generated features and the search query to determine a ranking of the plurality of items.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an item ranking system in accordance with some embodiments;

FIG. 2 is a block diagram of an item ranking computing device in accordance with some embodiments;

FIG. 3 is a block diagram illustrating examples of various portions of the item ranking system of FIG. 1 in accordance with some embodiments;

FIG. 4A is a block diagram illustrating examples of various portions of the item ranking computing device of FIG. 1 in accordance with some embodiments;

FIG. 4B is a block diagram illustrating examples of various portions of the item ranking computing device of FIG. 1 in accordance with some embodiments;

FIG. 4C illustrates a block diagram illustrating the generation of features for a plurality of items in accordance with some embodiments

FIGS. 5A and 5B are flowcharts of example methods that can be carried out by the item ranking computing device of FIG. 1 in accordance with some embodiments;

FIG. 6 is a flowchart of another example method that can be carried out by the item ranking computing device of FIG. 1 in accordance with some embodiments; and

FIGS. 7A, 7B, and 7C illustrate exemplary algorithms in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

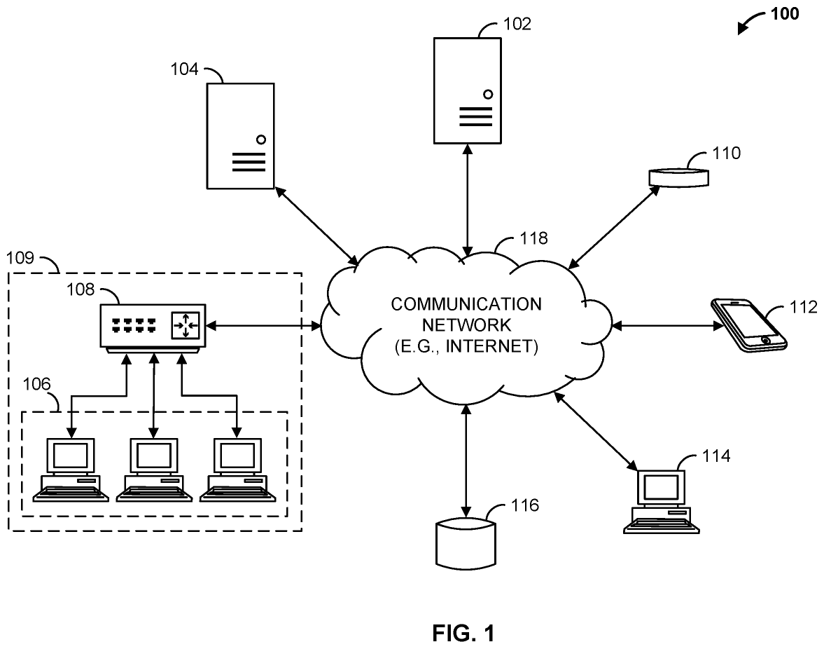

Turning to the drawings, FIG. 1 illustrates a block diagram of an item ranking system 100 that includes item ranking computing device 102 (e.g., a server, such as an application server), a web server 104, workstation(s) 106, database 116, an item recommendation system 105, and multiple customer computing devices 110, 112, 114 operatively coupled over network 118. Item ranking computing device 102, workstation(s) 106, server 104, item recommendation system 105, and multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 118.

In some examples, item ranking computing device 102 can be a computer, a workstation, a laptop, a server such as a cloud-based server, or any other suitable device. In some examples, each of multiple customer computing devices 110, 112, 114 can be a cellular phone, a smart phone, a tablet, a personal assistant device, a voice assistant device, a digital assistant, a laptop, a computer, or any other suitable device. In some examples, item ranking computing device 102 is operated by a retailer, and multiple customer computing devices 112, 114 are operated by customers of the retailer.

Although FIG. 1 illustrates three customer computing devices 110, 112, 114, item ranking system 100 can include any number of customer computing devices 110, 112, 114. Similarly, item ranking system 100 can include any number of workstation(s) 106, item ranking computing devices 102, web servers 104, item recommendation systems 105, and databases 116.

Workstation(s) 106 are operably coupled to communication network 118 via router (or switch) 108. Workstation(s) 106 and/or router 108 may be located at a store 109, for example. Workstation(s) 106 can communicate with item ranking computing device 102 over communication network 118. The workstation(s) 106 may send data to, and receive data from, item ranking computing device 102. For example, the workstation(s) 106 may transmit purchase data related to orders purchased by customers at store 109 to item ranking computing device 102. In some examples, item ranking computing device 102 may transmit, in response to received purchase data, an indication of one or more item advertisements to provide to a customer. For example, the item advertisements may be displayed on a receipt handed to the customer for the purchase order.

In some examples, web server 104 hosts one or more web pages, such as a retailer's website. The website may allow for the purchase of items. Web server 104 may transmit purchase data related to orders purchased on the website by customers to item ranking computing device 102. In some examples, web server 104 transmits user session data to item ranking computing device 102. The user session data identifies events associated with browsing sessions. Web server 104 may also transmit a search request to item ranking computing device 102. The search request may identify a search query provided by a customer. In response to the search request, item ranking computing device 102 may transmit an indication of one or more items to advertise to the customer, such as by displaying item advertisements on the website to the purchasing customer. For example, the item advertisements may be displayed on a search results webpage in response to a search query entered by a customer.

First customer computing device 110, second customer computing device 112, and N^{th} customer computing device 114 may communicate with web server 104 over communication network 118. For example, each of multiple computing devices 110, 112, 114 may be operable to view, access, and interact with the website hosted by web server 104. In some examples, the website allows a customer to search for items via, for example, a search bar. A customer operating one of multiple computing devices 110, 112, 114 may access the website via an executed browsing application and perform a search for items on the website by entering in one or more terms into the search bar. In response, the website may return search results identifying one or more items. The website may further allow the customer to add one or more of the items received in the search results to an online shopping cart, and allow the customer to perform a “checkout” of the shopping cart to purchase the items.

Item ranking computing device 102 is operable to communicate with database 116 over communication network 118. For example, item ranking computing device 102 can store data to, and read data from, database 116. Database 116 can be a remote storage device, such as a cloud-based server, a disk (e.g., a hard disk), a memory device on another application server, a networked computer, or any other suitable remote storage. Although shown remote to item ranking computing device 102, in some examples, database 116 can be a local storage device, such as a hard drive, a non-volatile memory, or a USB stick.

Item ranking computing device 102 may store purchase data received from store 109 and/or web server 104 in database 116. The purchase data may identify and characterize purchase transactions from a store ore website, for example. Item ranking computing device 102 may also store user session data identifying and characterizing events associated with browsing sessions, such as item engagements (e.g., item advertisement clicks, items added to an online cart) and item impressions (e.g., item advertisements viewed), in database 116. Database 116 may also store item catalog data characterizing and identifying one or more items and corresponding item attributes (e.g., product type, brand, options, features, etc.), such as for items sold at a store 109 or a retailer's website (e.g., hosted by webserver 104). In some examples, database 116 stores one or more machine learning models that, when executed by item ranking computing device 102, allows item ranking computing device 102 to determine one or more search results in response to a search query. Database 116 may also store feature data which may be used to train one or more of the machine learning models.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

Item ranking computing device 102 can execute trained machine learning models (e.g., algorithms) to determine a ranking of items in response to a search query. For example, item ranking computing device 102 may receive a search request for a website from web server 104. The search request may identify a search query provided by a customer (e.g., via a search bar on the website). Item ranking computing device 102 may generate features based on one or more of user session data, user transaction data, item catalog data, and the search query, as described herein, and may apply the trained machine learning model to the generated features to generate a ranking of items for the search query. Item ranking computing device 102 may transmit the ranking of items in response to the web server 104, where the web server 104 is configured to display item advertisements for the ranked items. For example, the web server 104 may display search results based on the received ranked items and in response to the provided search query.

The features may include query-item values generated for each of a plurality of search queries. The query-item values are based on a determined explicit, and implicit, intent of each search query, where the explicit and implicit intents are determined based on item engagements and corresponding item attributes for each of one or more items.

To generate the query-item values, item ranking computing device 102 determines items that correspond to each of a plurality of search queries based on engagement data. For example, item ranking computing device 102 may determine all items for which, in response to a search query, users clicked on an item a first threshold number of times (e.g., 50, 100, etc.), and/or added the item to their online shopping cart a second threshold number of times (e.g., 1, 10, etc.), over a period of time (e.g., over the last 30 days, the last three months, the last year, etc.). For example, item ranking computing device 102 may determine all items for which item advertisements have been clicked at least 50 times, and that have been added to an online shopping cart at least 1 time, over the last 30 days (e.g., by any customer, not just a same customer, visiting a retailer's website hosted by web server 104). Item ranking computing device 102 may obtain, from database 116 for example, user session data characterizing and identifying user engagements for each of the search queries to make the determinations.

Further, and for each search query, item ranking computing device 102 may determine a first value for each of the search query's corresponding items based on a first attribute of the items and engagements of each of the items. The first attribute may be a product type (e.g., outwear coats, candy, fruit), or any other suitable item attribute, for example. Item ranking computing device 102 may compute the first value based on a number of engagements for items with each product type with respect to all engagements for the determined items. For example, item ranking computing device 102 may determine that, out of the determined items, items with a first product type received a first percentage (e.g., 98%) of all of the engagements for the search query, and items with a second product type received a second percentage (e.g., 2%) of all of the engagements for the same search query. Item ranking computing device 102 may assign those items of the first product type with a first value based on the first percentage (e.g., 0.98), and may assign those items of the second product type with a first value based on the second parentage (e.g., 0.2).

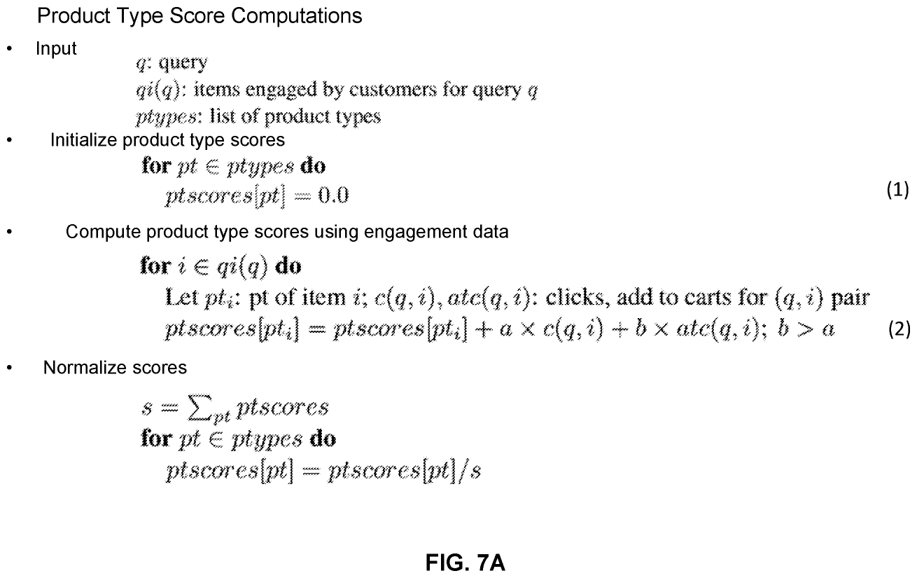

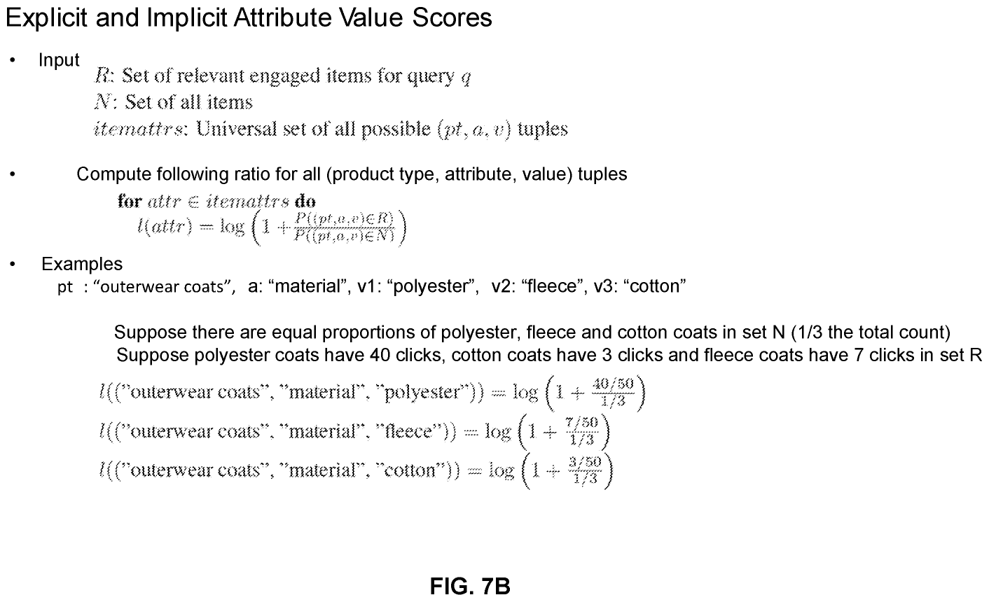

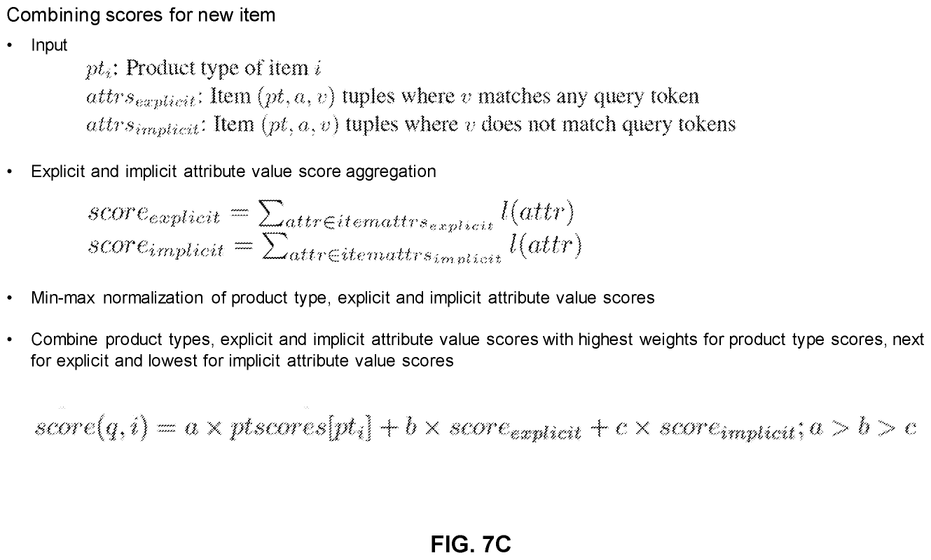

As an example, FIG. 7A illustrates an algorithm that may be executed by item ranking computing device 102 to compute first values for one or more items. In this example, and as indicated, the first values (as denoted by “ptscores”) is computed based on item engagements that include number of clicks (as denoted by “c”) and number of add-to-cart events (as denoted by “atc”). Weight “a” is applied to the clicks, and weight “b” is applied to the add-to-cart events. The weights may be configured by a user and stored in database 116, for example. Further, the individual “ptscores” are normalized based on a total number of “ptscores” (as denoted by “s”).

Referring back to FIG. 1, and for each search query, item ranking computing device 102 may determine a second value for each of the search query's corresponding items based on a second attribute of the items and the engagements of each of the items. The second attribute may be a product brand, or any other suitable item attribute, for example. The second attribute may include, for example, an attribute which is specified in the corresponding search query, thus reflecting an “explicit intent” of the search query. For example, a product brand may be included in the corresponding search query. Item ranking computing device 102 may compare one or more words of the search query to product brands defined within catalog data to determine the search query includes the product brand.

Item ranking computing device 102 may compute the second value, for items with a same first attribute (e.g., same product type), based on a number of engagements for each product brand with respect to all engagements for the determined items. For example, item ranking computing device 102 may determine that, out of the determined items with the first product type, items with a first product brand received a first number (e.g., 40) of all of the engagements for the search query, items with a second product brand received a second number (e.g., 7) of all of the engagements for the same search query, and items with a third product brand received a third number (e.g., 3) of all of the engagements for the same search query. Item ranking computing device 102 may assign those items of the first product brand with a second value based on the first number and the number of product brands for the first product type (e.g., 3 in this example), may assign those items of the second product type with a second value based on the second number and the number of product brands for the first product type, and may assign those items of the third product type with a second value based on the third number and the number of product brands for the first product type.

Similarly, for each search query, item ranking computing device 102 may determine a third value for each of the search query's corresponding items based on a third attribute of the items and the engagements of each of the items. The third attribute may be a product material, or any other suitable item attribute, for example. The third attribute may not include, for example, an attribute which is specified in the corresponding search query, thus reflecting an “implicit intent” of the search query. For example, the third attribute may be a product material which is not specified in the corresponding search query.

Item ranking computing device 102 may compute the third value, for items with the same first attribute (e.g., same product type), based on a number of engagements for each product material with respect to all engagements for the determined items. For example, item ranking computing device 102 may determine that, out of the determined items with the first product type, items with a first product material received a first number of all of the engagements for the search query, and items with a second product material received a second number of all of the engagements for the same search query. Item ranking computing device 102 may assign those items of the first product material with a third value based on the first number and the number of product materials for the first product type (e.g., 2 in this example), and may assign those items of the second product type with a second value based on the second number and the number of product materials for the first product type.

As an example, FIG. 7B illustrates an algorithm that may be executed by item ranking computing device 102 to compute second and third values for one or more items. In this example, “pt” denotes a particular product type (e.g., outerwear coats), “a” denotes a product attribute (e.g., product material), and “v” denotes the type of product attribute (e.g., polyester, fleece, cotton, etc.). Further, this example assumes that all outwear coats (e.g., that are sold or in inventory) are made of only one of three types of materials (i.e., polyester, fleece, or cotton). Further, the engagement data indicates, in response to a given search query, 40 of the outwear coats that were clicked (e.g., or added to a cart) have the product attribute of “polyester,” 7 of the outwear coats that were clicked (e.g., or added to a cart) have the product attribute of “fleece,” and 3 of the outwear coats that were clicked (e.g., or added to a cart) have the product attribute of “cotton.” Computations are illustrated to determine the second and/or third values, as denoted by “l( ).”

Although the examples above illustrates the determination of one “first value” for each item and search query pair, one “second value” for the item and search query pair (e.g., for an “explicit intent” attribute), and one “third value” for the item and search query pair (e.g., for an “implicit” intent attribute of the item), any number of “first values,” “second values,” and “third values” may be determined for each item and search query pair.

Further, for each search query, item ranking computing device 102 may store the determined first values, second values, and third values for each item in database 116. In some examples, the first, second, and third values are stored in one or more memory locations associated with the search query. For example, the one or more memory locations may correspond to a hash of the search query, or they may be determined based on a predetermined vector that includes the search queries.

Based on the first, second, and third values for each of the one or more items for a particular search query, item ranking computing device 102 computes a query-item value (e.g., query-item score). For example, and for a particular item and search query pair, item ranking computing device 102 may apply a first weight to the first value, a second weight to the second value, and a third weight to the third value, and may generate the query-item value based on the combination of the weighted values.

In some examples, item ranking computing device 102 aggregates all of the “explicit intent” values (e.g., second values) for an item and search query pair, and may similarly aggregate all of the “implicit intent” values (e.g., third values) for the item and the search query. Further, item ranking computing device 102 may apply the second weight to the aggregated second values, and the third weight to the aggregated third values, and may then generate the query-item value based on the combination of the weighted first, second, and third values.

FIG. 7C illustrates an exemplary computation of query-item values, denoted by “score(q, i),” where “score_{explicit}” denotes aggregated second values, and “score_{implicit}” denotes aggregated third values. In this example, weights “a,” “b,” and “c” are applied to the computed first values, aggregated second values, and aggregated third values, respectively, to generate the query-item values for each item and search query pair. The weights may be configured by a user and stored in database 116, for example.

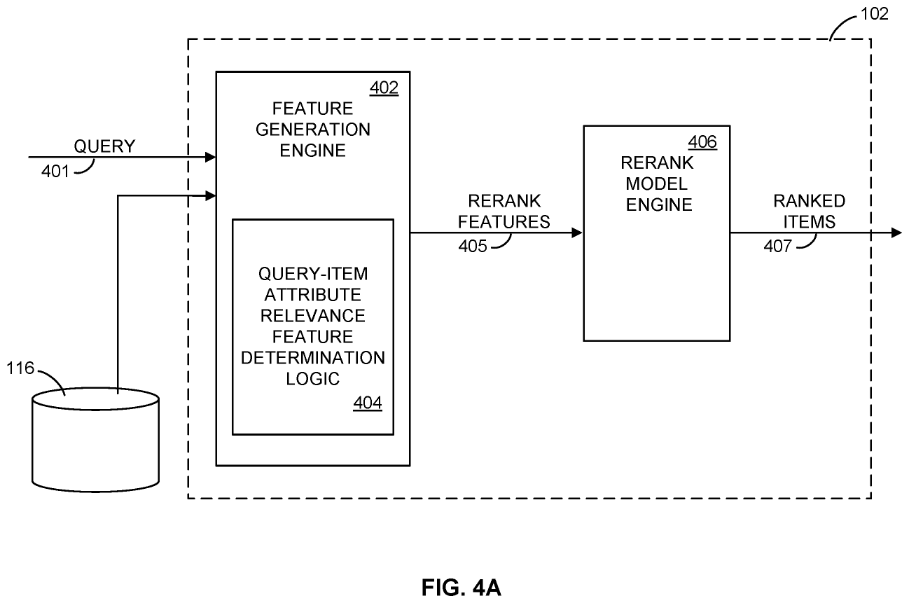

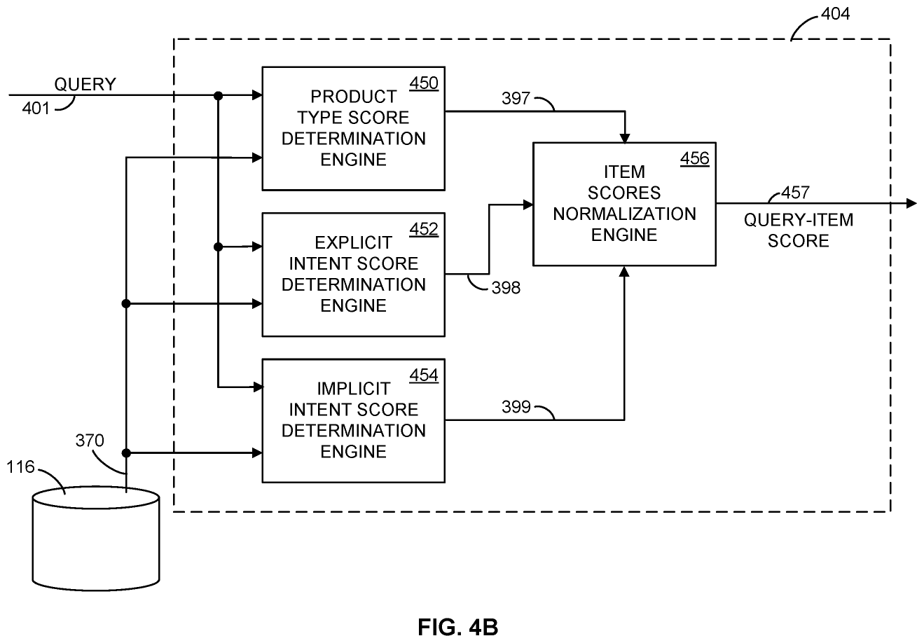

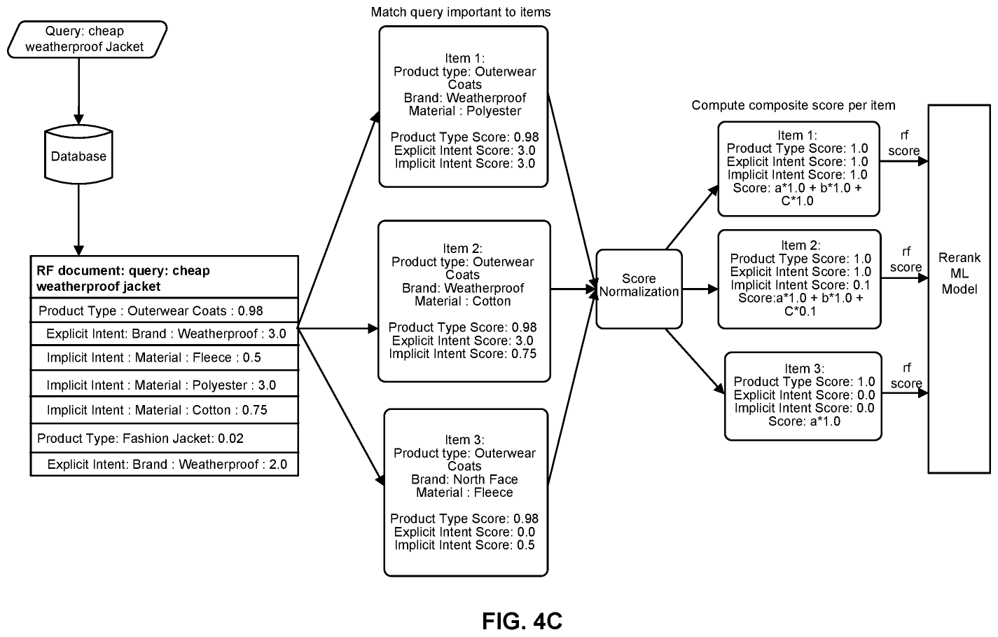

FIG. 4C illustrates an exemplary computation of query-item values for each of three items based on a received query of “cheap weatherproof jacket.” The query-item values for each of a first item, second item, and third item, and which are denoted by “rf score” (i.e., reference feature score), are based on a “product type score” (e.g., first value), an “explicit intent score” for a brand (e.g., second value), and an “implicit intent score” for a material (e.g., third value). The scores are provided as features to a re-rank machine learning model to generate a ranking of the three items.

Referring back to FIG. 1, for each search query, item ranking computing device 102 may store the generated query-item values in database 116. Further, item ranking computing device 102 may train a machine learning model, such as a decision tree model, random forest model, gradient boosting model, SVM model, neural network, or any other suitable machine learning model, with the generated query-item values. In some examples, the machine learning model is also trained with features generated from user session data and/or user transaction data.

Once trained, item ranking computing device 102 can apply the trained machine learning model to search queries to determine a ranking of items for the search query. For example, item ranking computing device 102 may receive a search query from web server 104, such as one provided by a user browsing a website. Once received, item ranking computing device 102 may obtain, from database 116, one or more corresponding first values (e.g., product type scores), second values (e.g., “explicit intent” scores), and third values (e.g., “implicit intent” scores) for the search query. For each of an initial set of items, item ranking computing device 102 determines the attributes associated with each item, and determines the corresponding one or more first values, second values, and third values for the item based on the item's attributes. Further, item ranking computing device 102 determines a query-item value for each item as described herein (e.g., see FIG. 7C and its corresponding description).

In some examples, item ranking computing device 102 determines the initial set of items for the search request based on the search query. For example, item ranking computing device 102 may apply one or more trained machine learning models to the search query to determine the initial set of items. In some examples, the initial set of items are obtained from a database, such as database 116. In some examples, the initial set of items are obtained from a recommendation system, such as a third-party server that provides item recommendations for a given search query. The initial set of items may, in some examples, be ranked (e.g., include an initial ranking score for each item).

Further, item ranking computing device 102 generates features based on the determined query-item values for the set of items, and applies a trained machine learning model to the features to generate a ranking of the set of items. In some examples, and based on the machine learning model, additional features are also generated, such as features based on user session data, user transaction data, the search query, and an initial ranking of the items, and these additional features are also provided to the trained machine learning model to generating the ranking of the set of items.

Item ranking computing device 102 may transmit the ranked items to web server 104. In response, web server 104 may display item advertisements for the ranked items. In some examples, reception of the ranked items causes web server 104 to display at least one item advertisement for each item in ranked order.

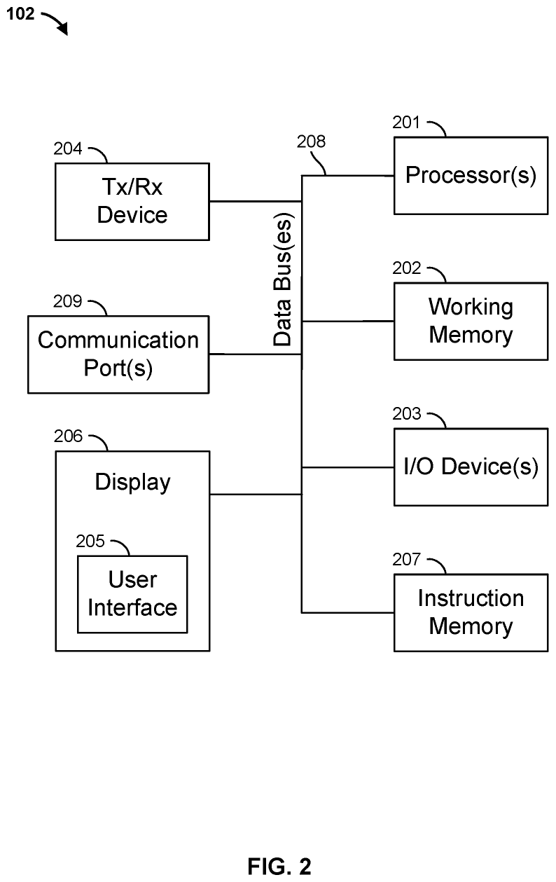

FIG. 2 illustrates the item ranking computing device 102 of FIG. 1. Item ranking computing device 102 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of item ranking computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as machine learning model training data.

Display 206 can display user interface 205. User interfaces 205 can enable user interaction with item ranking computing device 102. For example, user interface 205 can be a user interface for an application of a retailer that allows a customer to view and interact with a retailer's website. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 item ranking computing device 102 will be operating in. Processor(s) 201 is operable to receive data from, or send data to, a network, such as communication network 118 of FIG. 1, via transceiver 204.

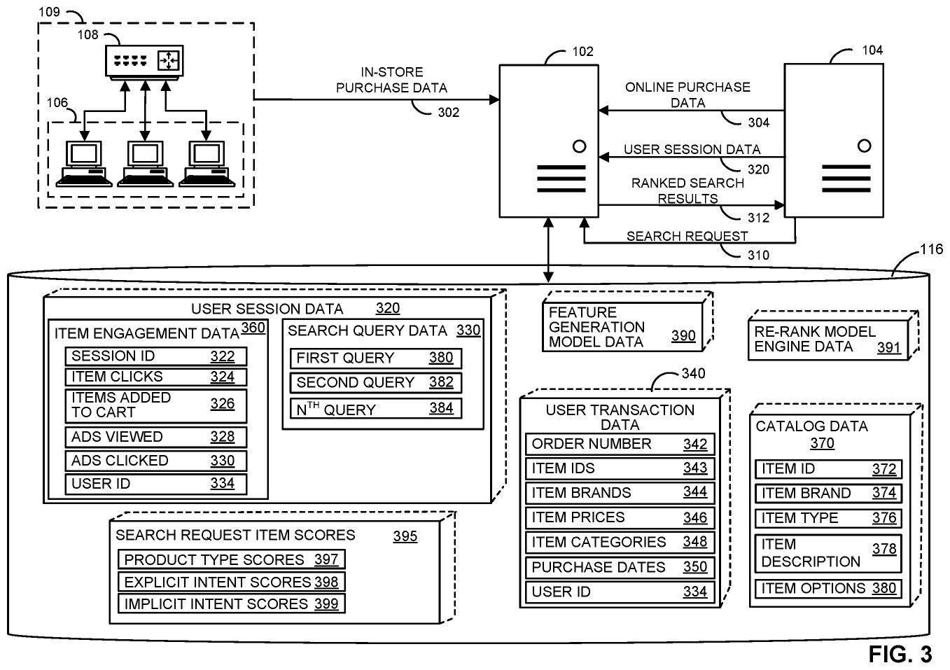

FIG. 3 is a block diagram illustrating examples of various portions of the item ranking system 100 of FIG. 1. As indicated in the figure, item ranking computing device 102 may receive user session data 320 from web server 104, and store user session data 320 in database 116. User session data 320 identifies, for each user, data related to a browsing session, such as when browsing a retailer's webpage hosted by web server 104. In this example, user session data 320 includes item engagement data 360 and search query data 330. Item engagement data 360 includes a session ID 322 (e.g., a website browsing session identifier), item clicks 324 identifying items which the user clicked (e.g., images of items for purchase, keywords to filter reviews for an item), items added-to-cart 326 identifying items added to the user's online shopping cart, advertisements viewed 328 identifying advertisements the user viewed during the browsing session, advertisements clicked 330 identifying advertisements the user clicked on, and user ID 334 ID (e.g., a customer ID, retailer website login ID, etc.). Search query data 330 identifies one or more searches conducted by a user during a browsing session (e.g., a current browsing session). In this example, search query data 330 includes first query 380, second query 382, and N^{th} query 384.

Item ranking computing device 102 may also receive in-store purchase data 302 identifying and characterizing one or more purchases from one or more stores 109. Similarly, item ranking computing device 102 may receive online purchase data 304 from web server 104, which identifies and characterizes one or more online purchases, such as from a retailer's website. Item ranking computing device 102 may parse in-store purchase data 302 and online purchase data 304 to generate user transaction data 340. In this example, user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item category 348 identifying a category of each item purchased, a purchase date 350 identifying the purchase date of the purchase order, and user ID 334 for the user making the corresponding purchase.

Database 116 may further store catalog data 310, which may identify one or more attributes of a plurality of items, such as a portion of or all items a retailer carries. Catalog data 310 may identify, for each of the plurality of items, an item ID 372 (e.g., an SKU number), item brand 374, item type 376 (e.g., grocery item such as milk, clothing item), item description 378 (e.g., a description of the product including product features, such as ingredients, benefits, use or consumption instructions, or any other suitable description), and item options 380 (e.g., item colors, sizes, flavors, etc.).

In some examples, item ranking computing device 102 may receive a search request 310 identifying and characterizing a search query for a user. The search query may include data identifying and characterizing one or more words, for example. Item ranking computing device 102 may determine an initial set of recommended items for the search query as described herein.

Further, item ranking computing device 102 may determine, for each of the initial set of recommended items, search request item scores 395 from database 116. Search request item scores 395 may include, for one or more items for each of a plurality of search queries, one or more product type scores 397 (e.g., “first values”), one or more explicit intent scores 398 (e.g., “second values”), and one or more implicit intent scores 399 (e.g., “third values”). Based on the corresponding product type scores 397, explicit intent scores 398, and implicit intent scores 399 for each of the initial set of items, item ranking computing device 102 may determine a query-item score for each item as described herein.

For example, for each item, item ranking computing device 102 may apply a first weight to a product type score 397, a second weight to aggregated explicit intent scores 398, and apply a third weight to aggregated implicit intent scores 399, and may generate the query-item score based on the combination of the weighted scores.

Item ranking computing device 102 may further generate features based on the query-item scores, and apply a trained machine learning model (e.g., a trained re-rank model) to the generated features to generate a ranking of the initial set of items. For example, item ranking computing device 102 may apply feature generation model data 390, which characterizes and identifies a model (e.g., algorithm) that generates features for the trained machine learning model, to the query-item scores to generate the features. In some examples, and based on the machine learning model, feature generation model data 390 generates additional features, such as features based on user session data, user transaction data, the search query, and an initial ranking of the items. Item ranking computing device 102 may then apply re-rank model engine data 116, which characterizes and identifies a trained machine learning model, to the generated features to generate ranked search results 312 characterizing and identifying the ranking of the set of items.

Item ranking computing device 102 may transmit the ranked search results 312 to web server 104, where ranked search results 312 identifies the re-ranked set of recommended items. Web server 104 may then display advertisements for the set of recommended items based on ranked search results 312.

FIG. 4A illustrates further exemplary portions of the item ranking computing device 102 of FIG. 1. As indicated in FIG. 4A, item ranking computing device 102 includes feature generation engine 402, which includes query-item attribute relevance feature determination logic 404, and re-rank model engine 406, which may be implemented within item ranking computing device 102.

In some examples, one or more of feature generation engine 402 and re-rank model engine 406 may be implemented in hardware. In some examples, one or more of feature generation engine 402 and re-rank model engine 406 may be implemented as an executable program maintained in a tangible, non-transitory memory, such as instruction memory 207 of FIG. 2, that may be executed by one or processors, such as processor 201 of FIG. 2.

In this example, feature generation engine 402 receives a search query 401 (e.g., from web server 104), and generates re-rank features 405. For example, query-item attribute relevance feature determination logic 404 of feature generation engine 402 may obtain, for each of an initial set of items, one or more product type scores 397 (e.g., “first values”), one or more explicit intent scores 398 (e.g., “second values”), and one or more implicit intent scores 399 (e.g., “third values”). Based on the corresponding product type scores 397, explicit intent scores 398, and implicit intent scores 399 for each of the initial set of items, query-item attribute relevance feature determination logic 404 may determine a query-item score for each item as described herein. Feature generation engine 402 may then generate re-rank features 405 based on the query-item scores. Further, in some examples, feature generation engine 402 may generate additional re-rank features 405 based on one or more of user session data 320, user transaction data 340, catalog data 370 (e.g., for the initial set of items), and any initial ranking of the items. Feature generation engine 402 provides the re-rank features 405 to re-rank model engine 406.

Re-rank model engine 406 includes one or more trained machine learning models, such as a machine learning model trained on query-item score based features, and applies the one or more trained machine learning models to re-rank features 405 to generate ranked items 407. In some examples, ranked items 407 includes, for each item, a numerical value identifying the item's ranking. Item ranking computing device 102 may generate the ranked search results 312 based on ranked items 407. For example, item ranking computing device 102 may parse ranked items 407 to extract the item rankings. Further, ranked search results 312 may include a message in accordance with a protocol established with, for example, web server 104. Item ranking computing device 102 may populate the message with the extracted item rankings in accordance with the established protocol, and may transmit the message, such as to web server 104.

FIG. 4B illustrates further details of the query-item attribute relevance feature determination logic 404 of FIG. 4A. As indicated in FIG. 4B, query-item attribute relevance feature determination logic 404 includes product type score determination engine 450, explicit intent score determination engine 452, implicit intent score determination engine 454, and query-item score generation engine 456.

Product type score determination engine 450 is configured to determine, based on the search query 401, a product type score 397 (e.g., “first value”) for each of an initial set of items. For example, product type score determination engine 450 may determine a product type of each of the initial set of items based on catalog data 370, and obtain, from database 116, a product type score 397 associated with the search query 401 for each of the items based on each item's determine product type.

Explicit intent score determination engine 452 is configured to determine, based on the search query 401, one or more explicit intent scores 398 (e.g., “second values”) for each of the initial set of items. For example, explicit intent score determination engine 452 may determine one or more attributes of each item (e.g., based on catalog data 370), and for each attribute obtain, from database 116, an explicit intent score 398 associated with the search query 401.

Implicit intent score determination engine 454 is configured to determine, based on the search query 401, one or more implicit intent scores 399 (e.g., “third values”) for each of the initial set of items. For example, implicit intent score determination engine 454 may determine one or more attributes of each item (e.g., based on catalog data 370), and for each attribute obtain, from database 116, an implicit intent score 399 associated with the search query 401.

For each of the initial set of items, query-item score generation engine 456 generates a query-item score 457 based on the item's corresponding product type score 397, one or more explicit intent scores 398, and one or more implicit intent scores 399 as described herein. For example, query-item score generation engine 456 may generate the query-item scores 457 as described above with respect to FIG. 7C.

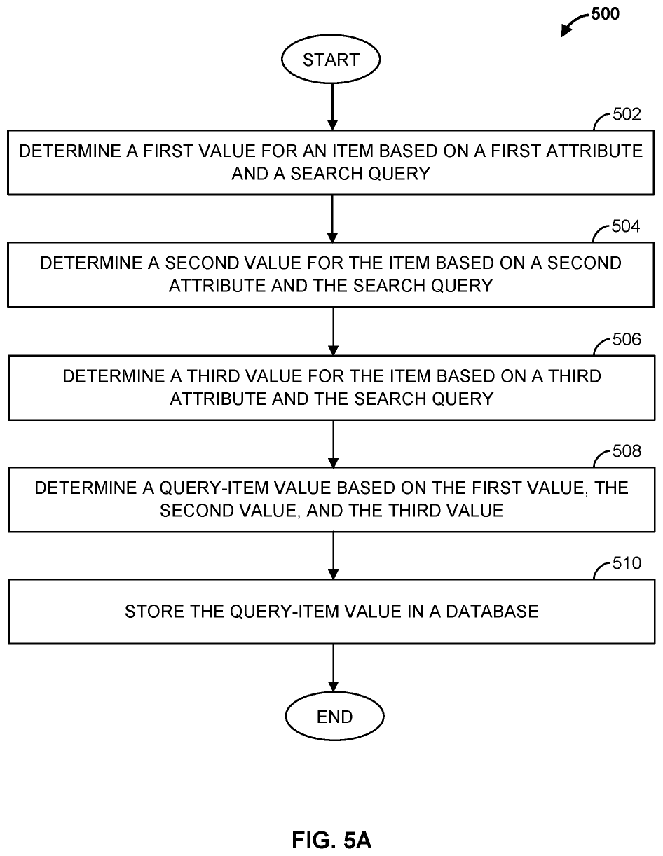

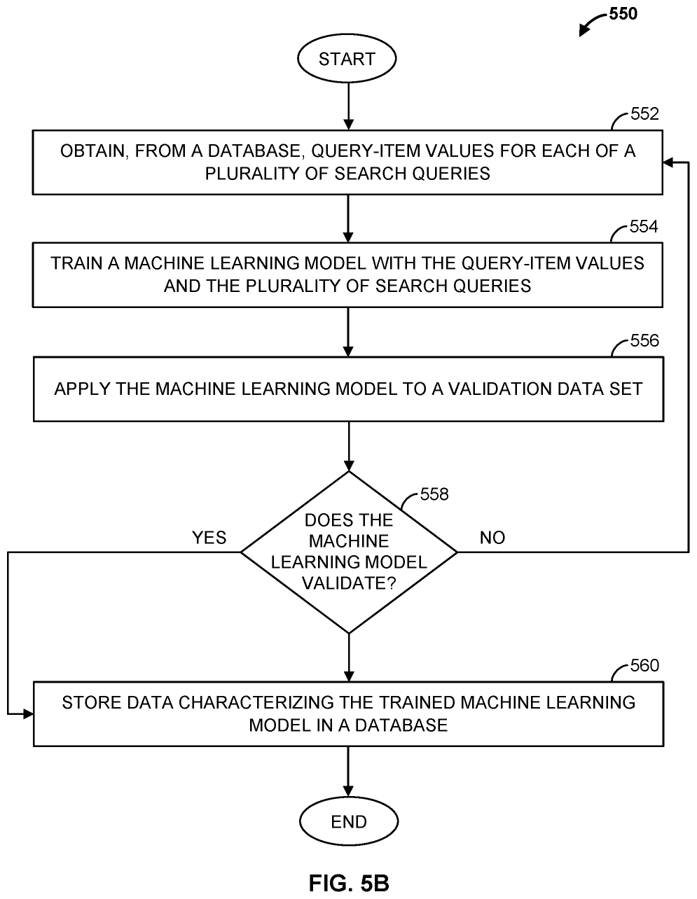

FIG. 5A is a flowchart of an example method 500 that can be carried out by the item ranking computing device 102 of FIG. 1. Beginning at step 502, a first value is determined for an item based on a first attribute and a search query. For example, and as described herein, item ranking computing device 102 may receive a search query 401, and may obtain from database 116 a product type score 397 for the item based on a product type (e.g., brand) of the item and the search query 401. The product type scores 397 may have been generated as described herein.

At step 504, a second value for the item is determined based on a second attribute and the search query. For example, and as described herein, item ranking computing device 102 may determine one or more attributes for each item based on catalog data 370, and may obtain, from database 116, one or more corresponding explicit intent scores 398 for the item based on the determined item attributes and the search query 401. The explicit intent scores 398 may have been generated as described herein.

At step 506, a third value for the item is determined based on a third attribute and the search query. For example, and as described herein, item ranking computing device 102 may determine one or more attributes for each item based on catalog data 370, and may obtain, from database 116, one or more corresponding implicit intent scores 399 for the item based on the determined item attributes and the search query 401. The implicit intent scores 399 may have been generated as described herein.

Further, and at step 508, a query-item value is determined based on the first value, the second value, and the third value. For example, and as described herein, item ranking computing device 102 may generate a query-item score 457 based on the item's corresponding product type score 397, one or more explicit intent scores 398, and one or more implicit intent scores 399. In some examples, a first weight is applied to the product type score 397, a second weight is applied to aggregated explicit intent scores 398, and a third weight is applied to aggregated implicit intent scores 399, and the query-item score 457 is generated based on the combination of the weighted scores.

At step 510, the query-item value is stored in a database, such as database 116. In some examples, features are generated based on generated query-item values, and a trained machine learning model is applied to the generated features to generate a ranking of items. The method then ends.

FIG. 5B is a flowchart of an example method 550 that can be carried out by the item ranking computing device 102 of FIG. 1. Beginning at step 552, query-item values for each of a plurality of search queries are obtained from a database. At step 554, a machine learning algorithm is trained with the query-item values and the plurality of search queries. For example, item ranking computing device 102 may generate features based on the query-item values and the plurality of search queries, and may train the machine learning model with the generated features.

At step 556, the machine learning model is applied to a validation data set. The validation data set may include search queries and, in some examples, a ranked item list (e.g., when using supervised learning). At step 558, a determination is made as to whether the machine learning model validates. For example, item ranking computing device 102 may compute one or more performance metrics (e.g., accuracy, precision, recall, F1-score, ROC, AUC, etc.) based on the output of the machine learning model during validation. If the one or more performance metrics are satisfied (e.g., one or more of the performance metrics meet or exceed a threshold), item ranking computing device 102 determines that the machine learning model validates. Otherwise, if the one or more performance metrics are not satisfied, item ranking computing device 102 determines that the machine learning model does not validate.

If the machine learning model fails to validate, the method proceeds back to step 552 for additional training of the machine learning model. Otherwise, if the machine learning model validates, the method proceeds to step 560.

At step 560, data characterizing the trained machine learning model is stored in a database. For example, item ranking computing device 102 may store re-rank model engine data 391 in database 116. The method then ends.

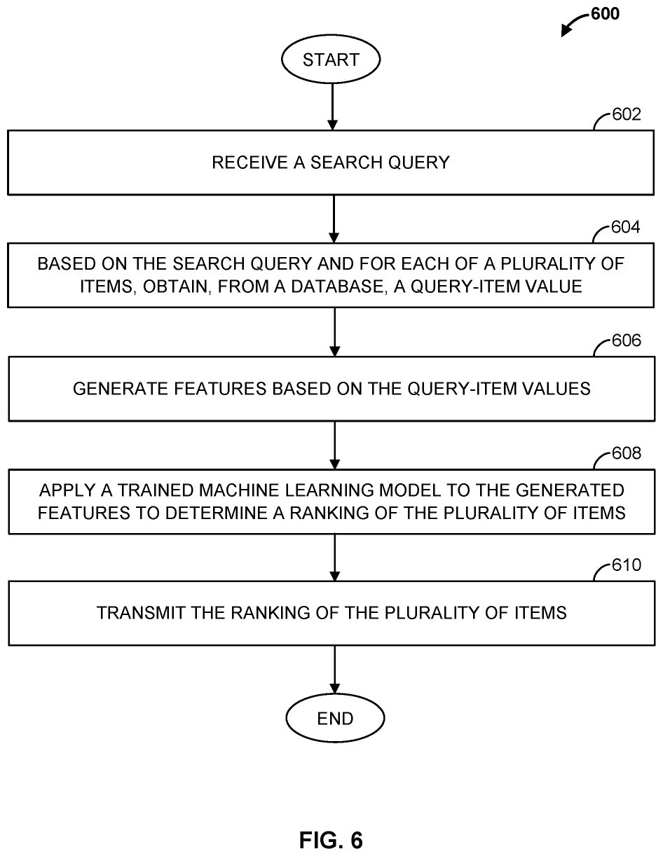

FIG. 6 is a flowchart of an example method 600 that can be carried out by the item ranking computing device 102 of FIG. 1. Beginning at step 602, a search query is received. At step 604, for each of a plurality of items, a query-item value is obtained from a database based on the search query. In some examples, the query-item value is computed based on each of the plurality of item's corresponding product type score 397, one or more explicit intent scores 398, and one or more implicit intent scores 399, as described herein.

At step 606, features are generated based on the query-item values. Further, and at step 608, a trained machine learning model is applied to the generated features to determine a ranking of the plurality of items. At step 610, the ranking of the plurality of items is transmitted. The method then ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a database; and
a computing device communicatively coupled to the database and configured to:
obtain, from the database, a plurality of search queries, engagement data identifying engagements of each of the plurality of items corresponding to each of the plurality of search queries, and a plurality of attributes for each of the plurality of items;
determine, for each search query of the plurality of search queries, a first value for each item of the plurality of items based on a first attribute of the plurality of items and the engagements of the item corresponding to each search query;
determine, for each search query of the plurality of search queries, a second value for each item of the plurality of items based on a second attribute of the plurality of items for the item and the engagements of the item corresponding to the search query;
determine, for each search query of the plurality of search queries, a third value for each item of the plurality of items based on a third attribute of the plurality of items for the item and the engagements of the item corresponding to the search query; and
store the first values, second values, and third values corresponding to each of the plurality of items for each of the plurality of search queries in the database.

2. The system of claim 1, wherein the computing device is configured to:
receive a search query request;
obtain, from the database, first values, second values, and third values corresponding to an initial set of items based on the search query request;
determine a query-item value for each of the initial set of items based on each item's corresponding first value, second value, and third value; and
apply a trained machine learning model to the query item values to generate a ranking of the initial set of items.

3. The system of claim 1, wherein the computing device is configured to:
determine, for each search query of the plurality of search queries, a query-item value for each item of the plurality of items based on each item's corresponding first value, second value, and third value for each search query;
generate features based on the query-item values; and
train a machine learning model with the generated features.

4. The system of claim 3, wherein determining the query-item value for each item of the plurality of items comprises applying a first weight to the first value, applying a second weight to the second value, and applying a third weight to the third value.

5. The system of claim 3, wherein the computing device is configured to:
apply the machine learning model to a validation data set to generate output data;
determine at least one performance metric based on the output data; and
determine whether the machine learning model is trained based on the at least one performance metric.

6. The system of claim 1, wherein the first attribute is a product type.

7. The system of claim 6, wherein the second attribute is a brand, and the third attribute is a material.

8. The system of claim 1, wherein the engagements of the item corresponding to each search query comprises clicks and add-to-cart events, and wherein determining the first value for each item of the plurality of items comprises:
determining a number of the click events;
determining a number of the add-to-cart events; and
applying a first weight to the number of the click events and applying a second weight to the number of add-to-cart events to determine the first value.

9. The system of claim 1, wherein determining the second value for each item of the plurality of items comprises:
based on the first attributes, determining a first number of the plurality of items with a same first attribute;
based on the second attributes, determining a second number of the first number of the plurality of items with a same second attribute; and
determining the second value based on each item's corresponding first attribute, corresponding second attribute, the first number of the plurality of items, and the second number of the plurality of items.

10. The system of claim 9, wherein determining the third value for each item of the plurality of items comprises:
based on the third attributes, determining a third number of the first number of the plurality of items with a same third attribute; and
determining the third value based on each item's corresponding first attribute, corresponding third attribute, the first number of the plurality of items, and the third number of the plurality of items.

11. A method comprising:
obtaining, from a database, a plurality of search queries, engagement data identifying engagements of each of the plurality of items corresponding to each of the plurality of search queries, and a plurality of attributes for each of the plurality of items;
determining, for each search query of the plurality of search queries, a first value for each item of the plurality of items based on a first attribute of the plurality of items and the engagements of the item corresponding to each search query;
determining, for each search query of the plurality of search queries, a second value for each item of the plurality of items based on a second attribute of the plurality of items for the item and the engagements of the item corresponding to the search query;
determining, for each search query of the plurality of search queries, a third value for each item of the plurality of items based on a third attribute of the plurality of items for the item and the engagements of the item corresponding to the search query; and
storing the first values, second values, and third values corresponding to each of the plurality of items for each of the plurality of search queries in the database.

12. The method of claim 11, comprising:
receiving a search query request;
obtaining, from the database, first values, second values, and third values corresponding to an initial set of items based on the search query request;
determining a query-item value for each of the initial set of items based on each item's corresponding first value, second value, and third value; and
applying a trained machine learning model to the query item values to generate a ranking of the initial set of items.

13. The method of claim 11, comprising:
determining, for each search query of the plurality of search queries, a query-item value for each item of the plurality of items based on each item's corresponding first value, second value, and third value for each search query;
generating features based on the query-item values; and
training a machine learning model with the generated features.

14. The method of claim 13, wherein determining the query-item value for each item of the plurality of items comprises applying a first weight to the first value, applying a second weight to the second value, and applying a third weight to the third value.

15. The method of claim 13, further comprising:
applying the machine learning model to a validation data set to generate output data;
determining at least one performance metric based on the output data; and
determining whether the machine learning model is trained based on the at least one performance metric.

16. The method of claim 11, wherein the engagements of the item corresponding to each search query comprises clicks and add-to-cart events, and wherein determining the first value for each item of the plurality of items comprises:
determining a number of the click events;
determining a number of the add-to-cart events; and
applying a first weight to the number of the click events and applying a second weight to the number of add-to-cart events to determine the first value.

17. The method of claim 11, wherein:
determining the second value for each item of the plurality of items comprises:
based on the first attributes, determining a first number of the plurality of items with a same first attribute;
based on the second attributes, determining a second number of the first number of the plurality of items with a same second attribute; and
determining the second value based on each item's corresponding first attribute, corresponding second attribute, the first number of the plurality of items, and the second number of the plurality of items; and
determining the third value for each item of the plurality of items comprises:
based on the third attributes, determining a third number of the first number of the plurality of items with a same third attribute; and
determining the third value based on each item's corresponding first attribute, corresponding third attribute, the first number of the plurality of items, and the third number of the plurality of items.

18. A non-transitory computer readable medium having instructions stored thereon, wherein the instructions, when executed by at least one processor, cause a device to perform operations comprising:
obtaining, from a database, a plurality of search queries, engagement data identifying engagements of each of the plurality of items corresponding to each of the plurality of search queries, and a plurality of attributes for each of the plurality of items;
determining, for each search query of the plurality of search queries, a first value for each item of the plurality of items based on a first attribute of the plurality of items and the engagements of the item corresponding to each search query;
determining, for each search query of the plurality of search queries, a second value for each item of the plurality of items based on a second attribute of the plurality of items for the item and the engagements of the item corresponding to the search query;
determining, for each search query of the plurality of search queries, a third value for each item of the plurality of items based on a third attribute of the plurality of items for the item and the engagements of the item corresponding to the search query; and
storing the first values, second values, and third values corresponding to each of the plurality of items for each of the plurality of search queries in the database.

19. The non-transitory computer readable medium of claim 18, further comprising instructions stored thereon that, when executed by at least one processor, further cause the device to perform operations comprising:
receiving a search query request;
obtaining, from the database, first values, second values, and third values corresponding to an initial set of items based on the search query request;
determining a query-item value for each of the initial set of items based on each item's corresponding first value, second value, and third value; and
applying a trained machine learning model to the query item values to generate a ranking of the initial set of items.

20. The non-transitory computer readable medium of claim 18 further comprising instructions stored thereon that, when executed by at least one processor, further cause the device to perform operations comprising:
determining, for each search query of the plurality of search queries, a query-item value for each item of the plurality of items based on each item's corresponding first value, second value, and third value for each search query;
generating features based on the query-item values; and
training a machine learning model with the generated features.
